(19) United States
(12) Patent Application Publication
(10) Pub. No.: US 2012/0154263 A1
(43) Pub. Date: Jun. 21, 2012

(54) LIQUID CRYSTAL DISPLAY DEVICE

(75) Inventors: Ikuko IMAJO, Chiba (JP); Kikuo ONO, Chiba (JP)

(73) Assignee: PANASONIC LIQUID CRYSTAL DISPLAY CO., LTD., Himeji-shi (JP)

(21) Appl. No.: 13/327,338

(22) Filed: Dec. 15, 2011

(30) Foreign Application Priority Data
Dec. 17, 2010 (JP) 2010-281127

(51) Int. Cl. G09G 3/36

(52) U.S. Cl. 345/102

(57) ABSTRACT

Provided is a liquid crystal display device capable of improving image quality of a display screen while reducing the number of light sources. A light source mounting substrate (42) formed on a backlight unit (4) has an elongated shape having a longitudinal direction aligned in a vertical scanning direction of the image, and has LED modules serving as light sources disposed at a plurality of positions in the longitudinal direction. A lens (45) is disposed above each of the light sources, for expanding light of the light source toward a region elongated in a horizontal scanning direction. A control device for controlling brightness of the plurality of light sources controls a light emission operation of the light sources in synchronization with selection of a scanning line in an operation of writing an image signal into the liquid crystal panel (2).

### CROSS-REFERENCE TO RELATED APPLICATION

The present application claims priority from Japanese application JP 2010-281127 filed on Dec. 17, 2010, the content of which is hereby incorporated by reference into this application.

### BACKGROUND OF THE INVENTION

1. Field of the Invention

The present invention relates to a liquid crystal display device, and more particularly, to a technology of improving image quality of a display screen while reducing the number of light sources in a backlight unit.

2. Description of the Related Art Japanese Patent Application Laid-open No. 2007-286627 discloses a liquid crystal display device including a direct type backlight unit. In the liquid crystal display device, a plurality of light emitting diodes (LEDs) are used as light sources of the backlight unit. The LEDs are disposed in matrix across an entire region of the backlight unit.

### SUMMARY OF THE INVENTION

However, in the liquid crystal display device disclosed in Japanese Patent Application Laid-open No. 2007-286627 described above, the LEDs are disposed across the entire region of the backlight unit, and hence a large number of LEDs are required, which is not preferred in terms of cost.

The present invention has been made in view of the above-mentioned problem, and provides a liquid crystal display device capable of improving image quality of a display screen while reducing the number of light sources in a backlight unit.

In order to solve the above-mentioned problem, a liquid crystal display device according to the invention includes: a liquid crystal panel capable of displaying an image; a backlight unit including a light source mounting substrate on which a plurality of light sources are disposed and which faces a rear surface of the liquid crystal panel; and a control device for controlling brightness of the plurality of light sources. The light source mounting substrate is shaped to have a longitudinal direction aligned in a vertical scanning direction of the image, and has the plurality of light sources disposed at a plurality of positions in the longitudinal direction. The backlight unit further includes a lens, which is disposed above each of the plurality of light sources, for expanding light of the each of the plurality of light sources toward a region elongated in a transverse direction of the light source mounting substrate, the transverse direction being orthogonal to the longitudinal direction on the liquid crystal panel. The control device controls a light emission operation of the plurality of light sources in synchronization with selection of a scanning line in an operation of writing an image signal into the liquid crystal panel.

According to the present invention, it is possible to reduce the number of light sources and reduce a residual image by performing control of the light sources in synchronization with the selection of the scanning line in the operation of writing the image signal into the liquid crystal panel.

Further, according to an aspect of the present invention, the backlight unit further includes a reflection sheet, which is disposed to be opposed to an image display region of the liquid crystal panel and reflects light from the plurality of light sources toward the image display region, and the reflection sheet has a reflection surface, which may be configured to form a concave surface curved in the transverse direction of the light source mounting substrate. According to this aspect, it becomes easier to direct the light of the light sources toward the liquid crystal panel.

Further, the liquid crystal display device according to an aspect of the present invention further includes a rear cabinet constituting a rear surface of the backlight unit, the backlight unit further includes a radiator plate, which is provided behind the plurality of light sources, and the rear cabinet contacts the radiator plate. According to this aspect, heat generated by the light sources is conducted to the rear cabinet, thereby enhancing heat dissipation efficiency.

The liquid crystal display device according to this aspect further includes reinforcing members, which are mounted to the rear cabinet and extend in the vertical scanning direction, and may be configured so that: the light source mounting substrate is disposed face to face with a center portion of the liquid crystal panel in the transverse direction of the light source mounting substrate; the reinforcing members are provided on both sides of a region in which the plurality of light sources are disposed; and the radiator plate is disposed so as to straddle the reinforcing members disposed in parallel to each other. According to this aspect, heat conduction and heat dissipation from the light sources to the rear cabinet are realized suitably by a simple structure as compared to the case where the light source mounting substrate is disposed in the lateral direction. Further, according to this aspect, the number of light sources can be reduced more easily.

Further, according to an aspect of the present invention, the light source mounting substrate may be disposed face to face with a center portion of the liquid crystal panel in the transverse direction of the light source mounting substrate. According to this aspect, the number of light sources can be reduced more easily.

Further, according to an aspect of the present invention, the plurality of light sources on the light source mounting substrate may be disposed in a row. According to this aspect, the number of light sources can be certainly reduced.

Further, according to an aspect of the present invention, the plurality of light sources on the light source mounting substrate may be disposed in two rows in a staggered manner. According to this aspect, the number of light sources can be reduced as compared to a conventional backlight unit, and the brightness can be increased due to the increase in array density of the light sources arranged in the vertical direction. In this aspect, the lens may include a first lens, which is disposed on the light source in a left row of the two rows, and a second lens, which is disposed on the light source in a right row of the two rows, the first lens may be formed so that light from the light source expands leftward intensively, and the second lens may be formed so that the light from the light source expands rightward intensively. According to this aspect, a region on the liquid crystal panel which is assigned to one light source can be made smaller to increase the brightness of each region, and light from the light source in one row is less affected by scattering or the like caused by the light source or the lens in the other row.

Further, according to an aspect of the present invention, the light source mounting substrate may include two light source mounting substrates disposed in parallel in the transverse direction. In this aspect, a configuration may be adopted in which the light sources on one of the two light source mounting substrates and the light sources on another one of the two light source mounting substrates are each disposed in a row, and are disposed in a staggered manner. According to this aspect, the number of light sources can be reduced as compared to a conventional backlight unit, and the brightness can be increased due to the increase in array density of the light sources arranged in the vertical direction.

### BRIEF DESCRIPTION OF THE DRAWINGS

In the accompanying drawings:

FIG. 1 is a schematic diagram illustrating a configuration of a liquid crystal display device according to an embodiment of the present invention;

FIG. 2 is a schematic cross-sectional view of a liquid crystal panel and a backlight unit included in the above-mentioned liquid crystal display device;

FIG. 3 is a front view of the backlight unit included in the above-mentioned liquid crystal display device;

FIG. 4 is a front view of a substrate (light source region) provided in the backlight unit of the above-mentioned liquid crystal display device;

FIG. 5 is a schematic view illustrating an example of another shape of a vertical cross section in a lateral direction of a reflection sheet provided in the above-mentioned backlight unit;

FIG. 6 is a schematic view illustrating an example of a shape of a vertical cross section in a vertical direction of the reflection sheet provided in the above-mentioned backlight unit;

FIG. 7 is a schematic view illustrating another example of the shape of the vertical cross section in the vertical direction of the reflection sheet provided in the above-mentioned backlight unit;

FIG. 8 is a perspective view of a lens disposed above an LED module of the above-mentioned backlight unit;

FIG. 9 is a cross-sectional view taken along the line IX-IX illustrated in FIG. 4;

FIG. 10 is a cross-sectional view taken along the line X-X illustrated in FIG. 4;

FIG. 11 is a schematic view illustrating a range of light expanded from one LED module in the backlight unit in which the lens of FIG. 8 is attached to each LED module;

FIG. 12 is a perspective view illustrating another example of the lens disposed above the LED module of the above-mentioned backlight unit;

FIG. 13 is a schematic view illustrating a range of light expanded from one LED module in the backlight unit in which the lens of FIG. 12 is attached to each LED module;

FIG. 14 is a schematic view illustrating a heat dissipation structure of the above-mentioned backlight unit;

FIG. 15 is a plan view of a substrate included in a liquid crystal display device according to another embodiment of the present invention;

FIG. 16 is a cross-sectional view taken along the line XVI-XVI illustrated in FIG. 15;

FIG. 17 is a schematic view illustrating a heat dissipation structure of a backlight unit including the substrate of FIG. 15 on which two rows of LED modules are disposed; and

FIG. 18 is a schematic view illustrating substrates and a heat dissipation structure in a backlight unit including two rows of LED modules.

### DETAILED DESCRIPTION OF THE INVENTION

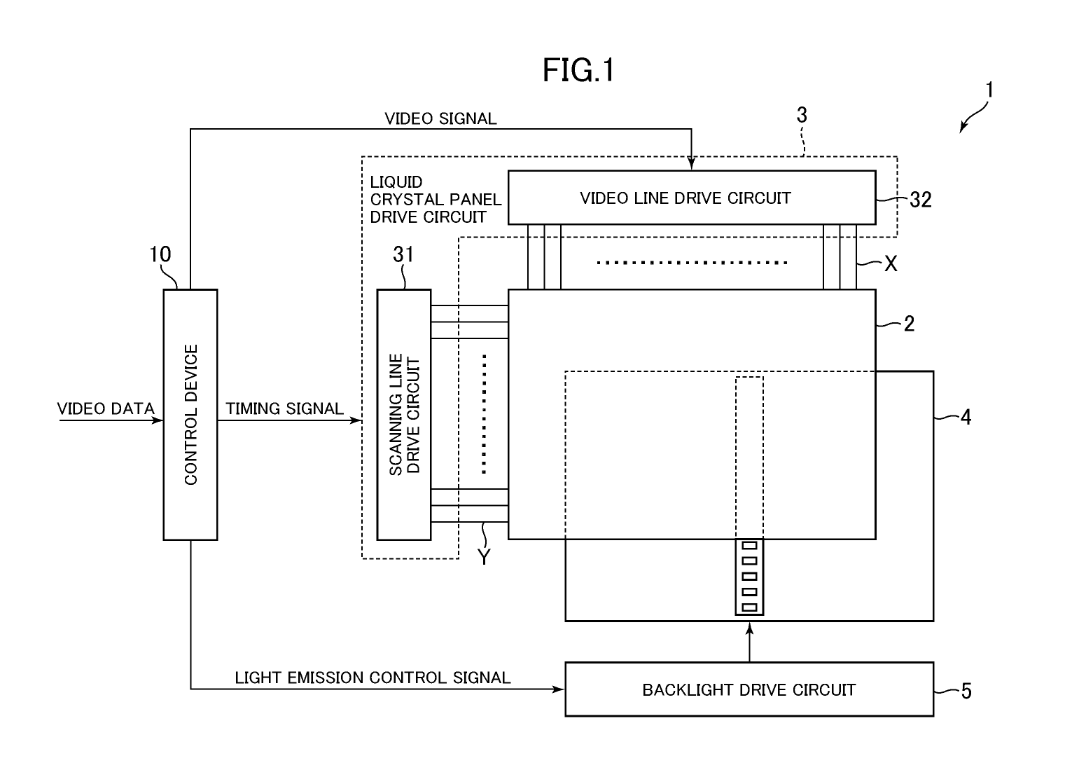

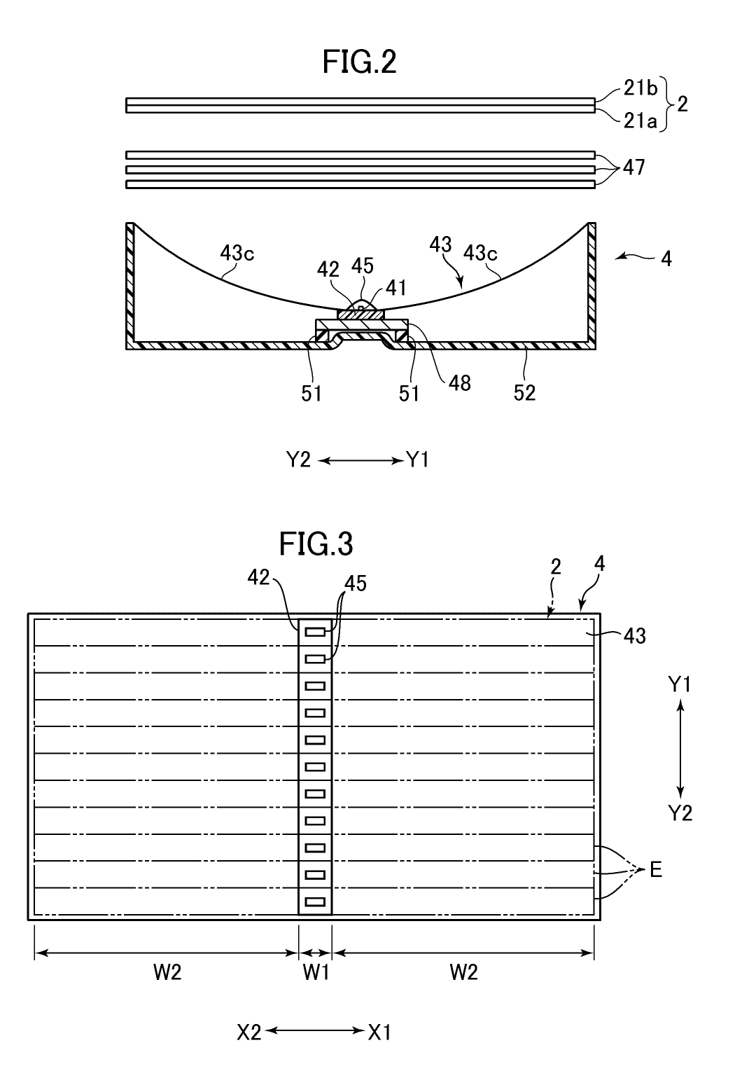

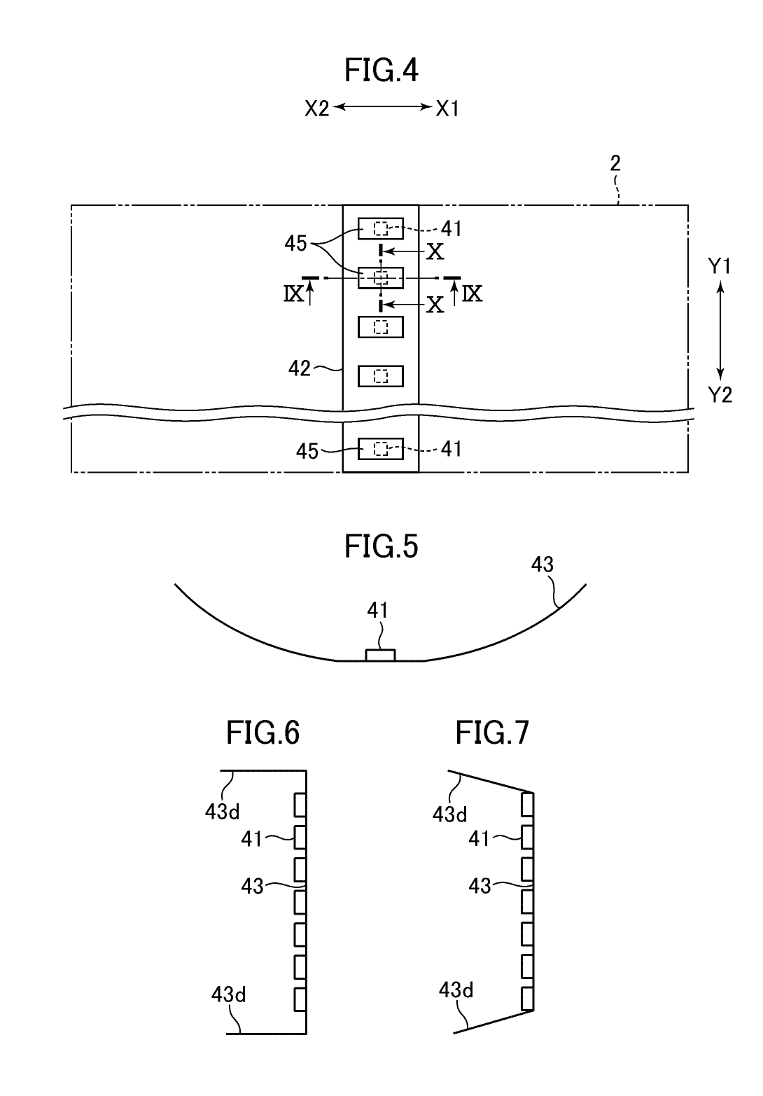

Hereinafter, an embodiment of the present invention is described with reference to the drawings. FIG. 1 is a schematic diagram illustrating a configuration of a liquid crystal display device 1 according to the embodiment of the present invention. FIG. 2 is a schematic cross-sectional view of a liquid crystal panel 2 and a backlight unit 4 included in the liquid crystal display device 1. FIG. 3 is a front view of the backlight unit 4 included in the liquid crystal display device 1, and FIG. 4 is a front view of a substrate (light source mounting substrate) 42 provided in the backlight unit 4.

As illustrated in FIGS. 1 and 2, the liquid crystal display device 1 includes a control device 10, the liquid crystal panel 2, and a liquid crystal panel drive circuit 3. The liquid crystal panel drive circuit 3 includes a scanning line drive circuit 31 and a video line drive circuit 32. Further, the liquid crystal display device 1 includes the backlight unit 4 and a backlight drive circuit 5.

The liquid crystal panel 2 has a rectangular shape, and the width of the liquid crystal panel 2 in a lateral direction (X1-X2 direction illustrated in FIG. 3) is larger than the width thereof in a vertical direction (Y1-Y2 direction illustrated in FIG. 3).

The liquid crystal panel 2 includes a pair of transparent substrates (specifically, glass substrates) 21a and 21b (see FIG. 2). On one substrate 21a (hereinafter, referred to as TFT substrate), a plurality of video signal lines X and a plurality of scanning signal lines Y are formed. The video signal lines X and the scanning signal lines Y are provided orthogonal to each other to form a grid pattern. A region surrounded by adjacent two video signal lines X and adjacent two scanning signal lines Y corresponds to one pixel. Further, in each of the pixels, a thin film transistor (TFT) (not shown) is provided. The TFT is turned ON by a scanning signal input from the scanning signal line Y, to thereby apply, to an electrode of each of the pixels, a voltage (signal representing a gradation value for each of the pixels) from the video signal line X. The scanning signal lines Y are provided corresponding to a plurality of horizontal scanning lines in a raster image such as a television image, and the pixels that are arranged in a row in the X1-X2 direction and controlled by each scanning signal line Y display one horizontal scanning line of a video image.

On the other substrate 21b, a color filter is formed. Liquid crystal (not shown) is sealed between the two substrates 21a and 21b. Polarization filters (not shown) are adhered to a display surface of the liquid crystal panel 2 and a rear surface thereof, which is the opposite surface of the display surface, respectively.

Into the control device 10, video data received by a tuner or an antenna (not shown) or video data generated in a different device such as a video reproducing device is input. The control device 10 includes a central processing unit (CPU) and a memory such as a read only memory (ROM) and a random access memory (RAM). The control device 10 performs various types of image processing, such as color adjustment, with respect to the input video data, and generates a video signal representing a gradation value for each of the pixels. The control device 10 outputs the generated video signal to the video line drive circuit 32. Further, the control device 10 generates, based on the input video data, a timing signal for synchronizing the video line drive circuit 32, the scanning line drive circuit 31, and the backlight drive circuit 5, and outputs the generated timing signal to the respective drive circuits.

Further, as described later, the backlight unit 4 is provided with a plurality of LED modules (light sources) 41 (see FIG. 4). The control device 10 generates a signal for controlling the brightness of the LED element 41 based on the input video data. Then, the control device 10 outputs the generated signal to the backlight drive circuit 5. The control of the LED module 41 performed by the control device 10 is described in detail later.

The scanning line drive circuit 31 is connected to the scanning signal lines Y formed on the TFT substrate 21a. The scanning line drive circuit 31 selects one of the scanning signal lines Y in order in response to the timing signal input from the control device 10, and the selected scanning signal line Y is applied with a voltage. When the voltage is applied to the scanning signal line Y, the TFTs connected to the scanning signal line Y are turned ON.

The video line drive circuit 32 is connected to the video signal lines X formed on the TFT substrate 21a. In conformity to the selection of the scanning signal line Y by the scanning line drive circuit 31, the video line drive circuit 32 applies, to each of the TFTs provided to the selected scanning signal line Y, a voltage corresponding to the video signal representing the gradation value of each of the pixels. With this, video signals are written into pixels corresponding to the selected scanning signal line Y. This operation corresponds to horizontal scanning of a raster image. On the other hand, the above-mentioned operation of the scanning line drive circuit 31 corresponds to vertical scanning.

The backlight unit 4 is provided on the rear surface side of the liquid crystal panel 2. The backlight unit 4 also has a rectangular shape, and the size thereof is set accordingly to that of the liquid crystal panel 2. Similarly to the liquid crystal panel 2, the width of the backlight unit 4 in the lateral direction is larger than the width thereof in the vertical direction.

As illustrated in FIG. 4, the backlight unit 4 includes the plurality of LED modules (light sources) 41. The backlight unit 4 irradiates the rear surface of the liquid crystal panel 2 with light emitted from the LED modules 41 (see FIG. 2). Each of the LED modules 41 includes an LED chip (light emitting element), a reflector for reflecting the light emitted from the LED chip, and an encapsulation resin, which encapsulates the LED chip and has light transmissive property.

As illustrated in FIGS. 3 and 4, the backlight unit 4 includes the substrate 42 onto which the plurality of LED modules 41 are mounted. The light source mounting substrate 42 has an elongated shape having a longitudinal direction aligned in a vertical scanning direction of a raster image, that is, the Y1-Y2 direction. The plurality of LED modules 41 are disposed at a plurality of positions in the longitudinal direction of the substrate 42. In the example described here, the plurality of LED modules 41 are disposed in a row in the longitudinal direction of the substrate 42. The substrate 42 is formed of an insulating material such as glass epoxy, paper phenol, and paper epoxy. The backlight unit 4 is a direct type backlight unit, and the substrate 42 is disposed so as to face the rear surface of the liquid crystal panel 2.

The size (width) of the substrate 42 in a transverse direction that is orthogonal to the longitudinal direction (Y1-Y2 direction) of the substrate 42 (X1-X2 direction; hereinafter, referred to as width direction of the substrate 42) is smaller than the size (length) in the longitudinal direction thereof. Therefore, the width of the substrate 42 is smaller than the sizes of the liquid crystal panel 2 and the backlight unit 4 in both the vertical and horizontal directions.

The substrate 42 is disposed substantially at a center portion of the backlight unit 4 in the lateral direction. That is, the substrate 42 is disposed face to face with a center portion of the liquid crystal panel 2 in the lateral direction. The LED modules 41 are provided only at the center portion of the backlight unit 4 in the lateral direction, and the LED module 41 is not provided in the other regions. As a result, the liquid crystal panel 2 includes, at the center portion in the lateral direction thereof, a region provided face to face with the LED modules 41 (hereinafter, referred to as opposing region). Further, the liquid crystal panel 2 includes, on the left side and the right side thereof, regions at which no LED modules 41 are provided face to face (hereinafter, referred to as non-opposing regions). A width W1 of the opposing region is smaller than a width W2 of each of the non-opposing regions.

As illustrated in FIG. 2, the backlight unit 4 includes a rear cabinet 52 forming the rear surface of the backlight unit 4. The substrate 42 is supported by the rear cabinet 52. Specifically, reinforcing members 51 are fixed on an inner side surface of the rear cabinet 52, the substrate 42 is mounted to a radiator plate 48, and the radiator plate 48 is fixed on the inner side of the rear cabinet 52 via the reinforcing members 51.

The backlight unit 4 further includes a reflection sheet 43, which is disposed to be opposed to an image display region of the liquid crystal panel 2. The reflection sheet 43 has, in plan view, a rectangular shape of a size set accordingly to that of the liquid crystal panel 2. The LED module 41 is positioned on the front surface (reflection surface) side of the reflection sheet 43. Therefore, light of the LED module 41 is emitted directly toward the liquid crystal panel 2, and is also reflected by the reflection sheet 43 toward the liquid crystal panel 2. Specifically, a surface of the reflection sheet 43 of this embodiment which is opposed to the liquid crystal panel 2, that is, the reflection surface, forms a concave surface that is curved (or bent) in the lateral direction thereof. The shape of the concave surface is set so that light emitted from the backlight unit 4 to the image display region of the liquid crystal panel 2 becomes uniform. The reflection sheet 43 is stored in the rear cabinet 52. Note that, a reflection surface 43c of the reflection sheet 43 does not necessarily change its inclination continuously. For example, a shape obtained by folding a straight line or a shape containing a straight line partially in a curve may be employed. FIG. 5 is a schematic view illustrating an example of another shape of the vertical cross section in the lateral direction of the reflection sheet. In the example illustrated in FIG. 5, the reflection sheet 43 is flat at a center portion in the vicinity of the LED module 41, and is curved at portions outside the center portion.

FIGS. 6 and 7 are schematic views each illustrating an example of the shape of the vertical cross section in the vertical direction of the reflection sheet. FIGS. 6 and 7 each illustrate the cross section at the center portion at which the LED modules 41 are arrayed. The reflection sheet 43 has side surfaces 43d which rise toward the reflection surface 43c side from the upper and lower edges of the concave surface and reach a plane passing through the right and left end portions of the concave surface. The right and left end portions and the side surfaces 43d of the reflection sheet 43 form the rectangle having the size corresponding to the liquid crystal panel 2. The reflection sheet 43 of FIG. 6 has a configuration in which the size of the concave surface portion in the vertical direction is set so as to match the size of the liquid crystal panel 2 in the vertical direction, and the side surfaces 43d are disposed substantially in parallel to the optical axis of the LED modules 41. The reflection sheet 43 of FIG. 7 has a configuration in which the size of the concave surface portion in the vertical direction is set so as to match the length of the array of the LED modules 41, the side surfaces 43d are disposed to be inclined corresponding to the difference in size in the vertical direction between the concave surface portion and the liquid crystal panel 2, and the side surfaces 43d expand in the vertical direction toward the liquid crystal panel. Note that, FIGS. 5, 6, and 7 illustrate only the LED modules 41 and the reflection sheet 43 and omit the other configurations of the backlight unit 4.

The substrate 42 is positioned on the rear surface of the reflection sheet 43. The reflection sheet 43 is formed so as to avoid the positions of the LED modules 41. Specifically, the reflection sheet 43 has a plurality of holes formed therein. The reflection sheet 43 is overlapped on the front surface of the substrate 42, and each of the LED modules 41 is positioned on the inner side of the hole formed in the reflection sheet 43.

Further, as illustrated in FIG. 2, the backlight unit 4 includes a plurality of optical sheets 47. The optical sheets 47 are positioned between the LED modules 41 and the liquid crystal panel 2. The optical sheets 47 include a diffusion sheet for diffusing the light emitted from the LED modules 41 and a prism sheet. The number of the optical sheets 47 is set arbitrarily depending on optical design of a product. There may be a case where a diffusion plate and a plurality of prism sheets are used in combination or a case where only a diffusion plate is used.

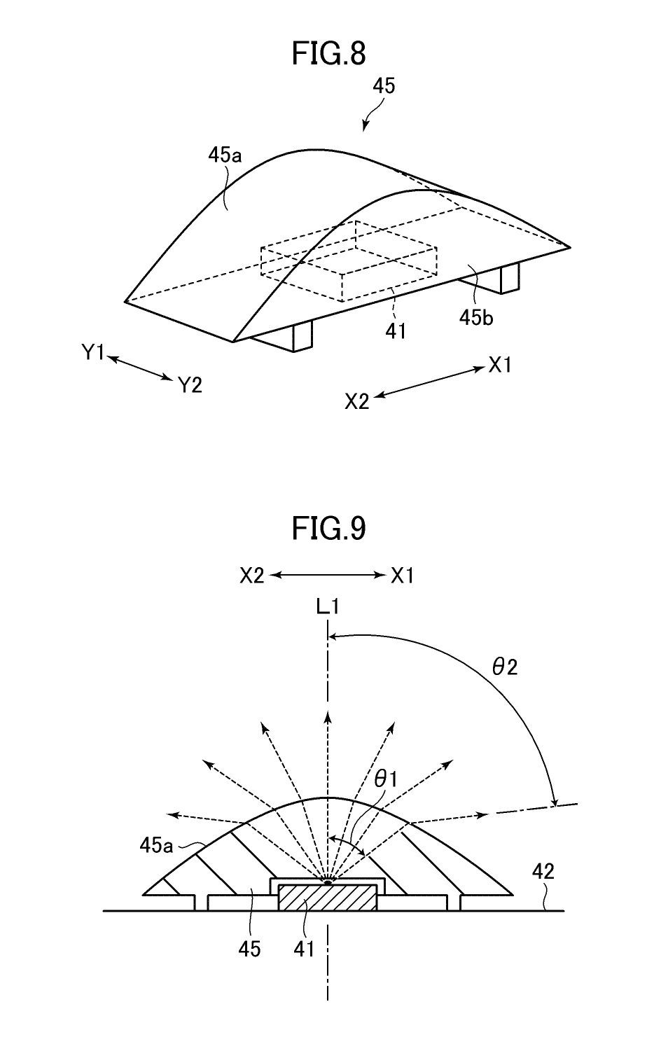

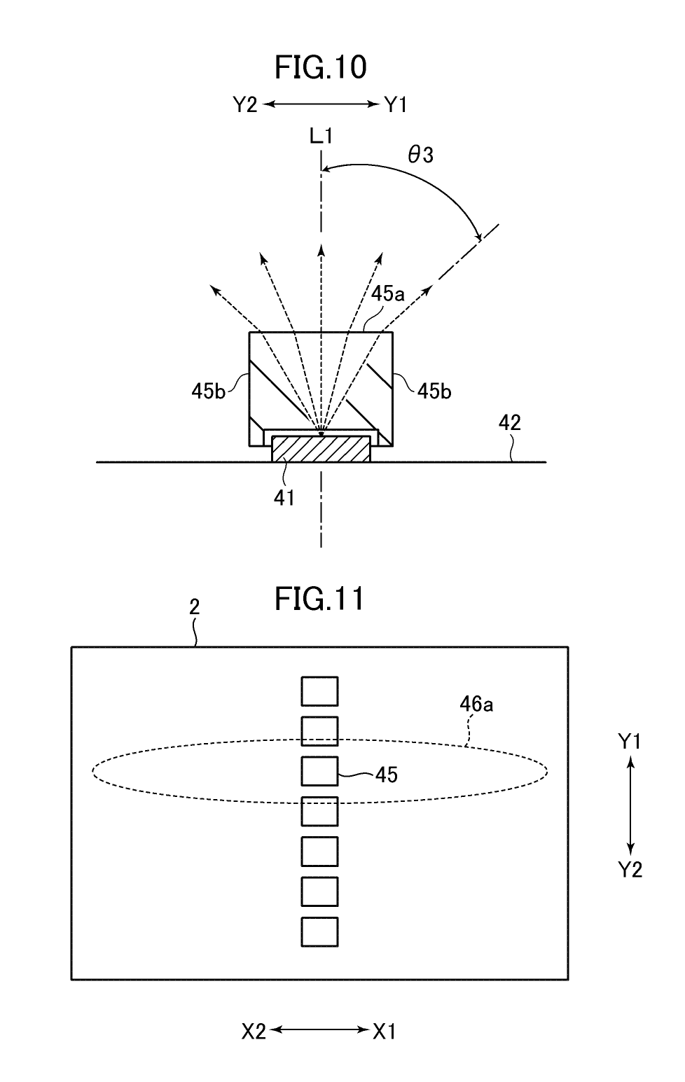

As illustrated in FIG. 4, the backlight unit 4 includes lenses 45 that are separately provided from the LED modules 41. FIG. 8 is a perspective view of the lens 45. FIG. 9 is a cross-sectional view taken along the line IX-IX illustrated in FIG. 4. FIG. 10 is a cross-sectional view taken along the line X-X illustrated in FIG. 4.

The lens 45 is disposed over the LED module 41, and the light emitted from the LED module 41 enters the lens 45. The light emitted from the LED module 41 is transmitted through the lens 45, and exits toward the rear surface of the liquid crystal panel 2. In this example, the lens 45 is disposed over each of the LED modules 41. The lens 45 is larger than the LED module 41 in plan view, and is disposed so as to cover the LED module 41.

The divergence angle (exit angle range, for example, θ1 in FIG. 9) of light emitted from the LED module 41 is expanded by the lens 45. The divergence angle is an angle representing the expanse of light emitted from each of the LED modules 41. The divergence angle is, for example, an angle with respect to an optical axis of the LED module 41 (straight line L1 in FIGS. 9 and 10, corresponding to a straight line which passes through the center of the LED module 41 and is perpendicular to the substrate 42).

As illustrated in FIG. 3, the liquid crystal panel 2 is sectioned into a plurality of partial regions E. To each of the LED modules 41, any one of the partial regions E is assigned. That is, to each of the LED modules 41, the partial region E toward which light emitted from the LED module 41 is desirably directed is associated. One LED module 41 may be associated with one partial region E, and alternatively a plurality of LED modules 41 may be associated with one partial region E.

As illustrated in FIG. 3, the partial region E is a region extended in the width direction of the substrate 42, and is a substantially rectangular region elongated in the vertical direction. Corresponding to the plurality of LED modules 41 that are arrayed in the vertical direction, the partial regions E are also arranged in the vertical direction. Note that, the shape of the partial region E is not limited to the shape illustrated in FIG. 3. For example, the width of the partial region E may gradually increase as the distance from the substrate 42 increases. Further, the partial region E may be defined so as to have a portion overlapping with the adjacent partial region E. Basically, each partial region E is set in an image display region corresponding to the same number of scanning signal lines Y.

The lens 45 expands the light emitted from the LED module 41 mainly toward the partial region E assigned to the LED module 41. That is, as illustrated in FIGS. 9 and 10, the lens 45 expands the light so that the divergence angle of the light emitted from the LED module 41 is not equally expanded in all radial directions with its optical axis L1 as a center, but is expanded so as to be deflected in a direction toward the partial region E. In the example described here, the partial region E is a region elongated in the lateral direction. Therefore, the lens 45 expands the divergence angle of the light mainly in the lateral direction, and emits the light toward the left side and the right side of the substrate 42. As a result, the divergence angle of the light in the lateral direction (θ2 in FIG. 9) is larger than the divergence angle expanded in any other directions (for example, the divergence angle in the vertical direction (θ3 in FIG. 10)).

The light which exits from the lens 45 leftwardly or rightwardly is reflected by the reflection surface 43c forming the inclined surface of the reflection sheet 43. Thus, the light emitted from the LED module 41 is also applied to the non-opposing regions which are the regions of the liquid crystal panel 2, at which no LED modules 41 are provided face to face.

As illustrated in FIG. 8, a light exiting surface (top surface) 45a of the lens 45 is a curved surface formed into a convex shape. The light exiting surface 45a includes inclined surfaces which gradually approach the substrate 42 as being deviated in the lateral direction from the apex of the lens 45. The light exiting surface 45a is a surface that can be formed by parallel translation of a straight line extending in the vertical direction. Further, the lens 45 has a pair of side surfaces 45b facing in opposite directions (see FIG. 10). The side surfaces 45b extend downward from the upper and lower edges of the light exiting surface 45a toward the substrate 42. In this example, the side surfaces 45b are flat surfaces formed perpendicularly to the substrate 42, and are substantially parallel to the optical axis of the LED module 41. Therefore, the expanse of the divergence angle in the longitudinal direction of the substrate 42 is suppressed. Further, the lens 45 has, in plan view, a substantially rectangular shape elongated in the lateral direction.

FIG. 11 is a schematic view illustrating the backlight unit 4 in which the lenses 45 of FIG. 8 are attached to the LED modules 41 in plan view, and illustrates a range 46a of light expanded from one LED module 41. The irradiation range 46a of the lens 45 whose light exiting surface 45a has the curvature only in the lateral direction as illustrated in FIG. 8 expands in the lateral direction but less expands in the vertical direction.

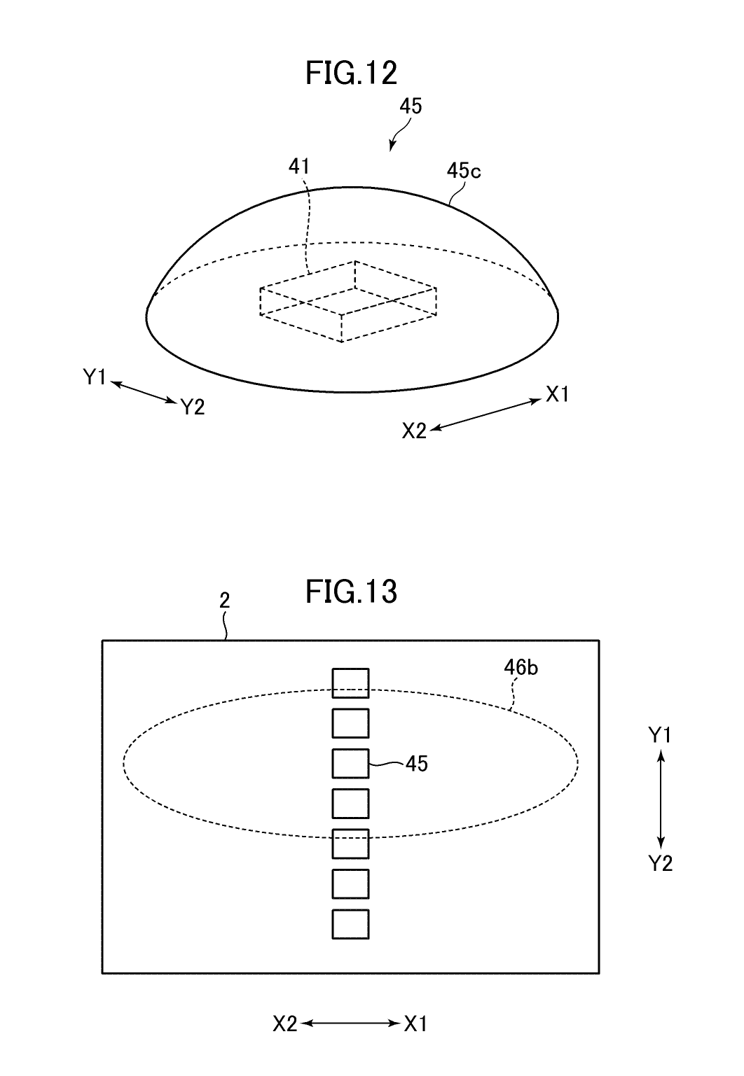

Note that, the shape of the lens 45 is not limited thereto. For example, the lens 45 may be isotropic with a circular planar shape. FIG. 12 is a schematic perspective view illustrating a lens 45 which is formed in such circular shape. A light exiting surface 45c of the lens 45 is a curved shape having the isotropic curvature.

FIG. 13 is a schematic view illustrating the backlight unit 4 in which the lenses 45 of FIG. 12 are attached to the LED modules 41 in plan view, and illustrates a range 46b of light expanded from one LED module 41. The light exiting surface 45c of the lens 45 of FIG. 12 is different from the light exiting surface 45a of the lens 45 of FIG. 8 in that the light exiting surface 45c has curvatures not only in the lateral direction but also in the vertical direction. With this, an irradiation range 46b of the lens 45 of FIG. 12 expands more in the vertical direction than the irradiation range 46a of the lens of FIG. 8. Note that, the irradiation range 46b in FIG. 1 is of a horizontally-elongated shape because the reflection surface 43c of the reflection sheet 43 forms a concave surface in the lateral direction.

Note that, the LED modules 41 are arrayed in the vertical scanning direction. Corresponding thereto, as described later, the control device 10 performs scroll control in which, in synchronization with selection of a scanning line in an operation of writing an image signal into the liquid crystal panel 2, the operation of the LED module 41 at a position corresponding to the selected scanning line is controlled. In the scroll control, it is better that the irradiation ranges of light between LED modules 41 adjacent in the vertical direction be less overlapped with each other. In this respect, the lens 45 of FIG. 8 is more advantageous between the above-mentioned two kinds of lenses 45 illustrated in FIG. 8 and FIG. 12.

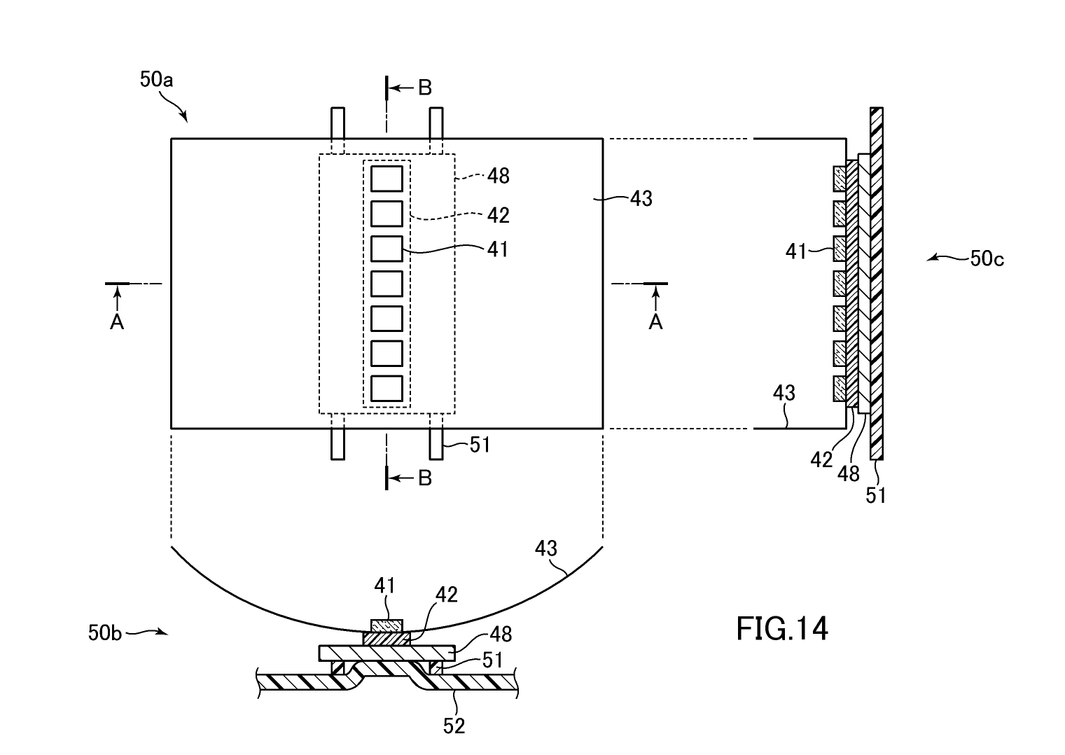

FIG. 14 is a schematic view illustrating a heat dissipation structure of the backlight unit 4, and illustrates a plan view 50a of the backlight unit 4, a horizontal cross-sectional view 50b taken along the line A-A illustrated in the plan view 50a, and a vertical cross-sectional view 50c taken along the line B-B illustrated in the plan view 50a. FIG. 14 is a simplified schematic view of the backlight unit 4, and omits the lens 45, for example.

The backlight unit 4 is provided with two reinforcing members 51 extending in the vertical direction. The reinforcing members 51 are disposed inside the rear cabinet 52 in parallel to each other at an interval and symmetrically about the center of the backlight unit 4 in the horizontal direction. The reinforcing members 51 may be attached with a bracket for mounting the liquid crystal display device 1 on the wall.

The radiator plate 48 is disposed to straddle the two reinforcing members 51. In other words, the radiator plate 48 is disposed at a center portion of the backlight unit 4 in the horizontal direction so as to correspond to the arrangement of the LED modules 41 and the substrate 42, and the radiator plate 48 is formed to have a width sufficient to straddle between the two reinforcing members 51. Then, the radiator plate 48 is fixed onto the reinforcing members 51 mounted in the rear cabinet 52.

Note that, the size of the radiator plate 48 in the horizontal direction is set to be smaller than the size of an effective display area of the liquid crystal display device 1 in the horizontal direction. Basically, the upper end of the radiator plate 48 can be set to align with or be inside the upper end of the effective display area. On the other hand, the lower end of the radiator plate 48 can be set to align with or be inside the lower end of the effective display area, and may be configured so that the radiator plate 48 extends off the lower end of the effective display area or the backlight unit 4. For example, a portion of the radiator plate 48 which protrudes downward from the lower end of the backlight unit 4 or the like can be used for disposing the board such as the drive circuit for the LED modules 41.

The substrate on which the LED modules 41 are mounted is configured so that the LED modules 41 do not overlap the mounting positions of the reinforcing members 51. That is, the positions of the LED modules 41 in the lateral direction are set within an interval between the two reinforcing members 51, which is basically set to be larger than the width of the LED modules 41. Specifically, in this embodiment, the substrate 42 is disposed face to face with the center portion of the liquid crystal panel 2, and the LED modules 41 are disposed at the center of the backlight unit 4 in the lateral direction.

As illustrated in the horizontal cross-sectional view 50b, the rear cabinet 52 is in contact with the radiator plate 48 at a position at which the reinforcing members 51 are not mounted. In other words, the reinforcing members 51 are provided on both sides of the region in which the LED modules 41 are disposed. With this, the rear cabinet 52 can contact the radiator plate 48 behind the region in which the LED modules 41 are disposed. Heat generated in the LED modules 41 is transferred to the radiator plate 48 via the substrate 42. The radiator plate 48 absorbs the generated heat of the LED modules 41 corresponding to its large heat capacity and dissipates the heat to the air, and further transfers the generated heat of the LED modules 41 to the rear cabinet 52. The rear cabinet 52 contacts the radiator plate 48 behind the LED modules 41, and therefore the generated heat of the LED modules 41 can be transferred and dissipated efficiently. Note that, in the case where the LED modules 41 are arrayed in the horizontal direction unlike this embodiment, the array of the LED modules 41 has portions that cross the reinforcing members 51 extending in the vertical direction. In the portions, gaps are generated between the radiator plate 48 behind the LED modules 41 and the rear cabinet 52. Therefore, there may occur inconvenience that heat dissipation of the LED modules 41 becomes non-uniform or the shape of the rear cabinet 52 becomes complicated. In this respect, in the configuration of this embodiment in which the LED modules 41 are arrayed in the vertical direction, the LED modules 41 can be disposed so as not to cross the reinforcing members 51 as described above, and hence such inconvenience can be avoided.

Hereinafter, an example of processing executed by the control device 10 is described. The control device 10 controls, in synchronization with selection of a scanning line in an operation of writing an image signal into the liquid crystal panel 2, the operation of an LED module 41 at a position corresponding to the selected scanning line among the plurality of LED modules 41 arrayed in the vertical direction. Specifically, the operation of the LED module 41 corresponding to the partial region E containing a scanning signal line Y that selects pixels to be written is controlled. For example, the control device 10 performs control such that the LED module 41 corresponding to the partial region E containing the scanning signal line that selects pixels for write operation is turned OFF during the write operation, and is turned ON after the write operation. In this control, in conjunction with vertical scanning of image signals, the LED modules 41 are turned OFF sequentially in the vertical direction. The control is herein referred to as scroll control.

By performing the scroll control, a pixel which is being overwritten is prevented from displaying an image, to thereby reduce a residual image phenomenon during moving image display. Therefore, higher quality of a displayed image can be attained. Further, in three-dimensional image display (3D display) in which an image for the left eye and an image for the right eye are displayed alternately, the overwriting states of the right and left images can be preventing from being displayed in a screen. Thus, high quality 3D display can be realized.

As described above, in the liquid crystal display device 1, the width of the substrate 42 is smaller than the size of the liquid crystal panel 2 in the horizontal direction, and the plurality of LED modules 41 are arranged along the vertical direction. Further, each of the LED modules 41 is assigned with the partial region E extended in the lateral direction, and on the each LED module 41, the lens 45 for expanding light from the LED module 41 toward the partial region E is disposed. Therefore, while reducing the number of the LED modules 41, the light can be directed toward the entire liquid crystal panel 2.

Note that, the present invention is not limited to the liquid crystal display device 1 described above, and various modifications can be made thereto.

For example, in the above description, each lens 45 allows light from the LED module 41 to diverge symmetrically to both the left side and the right side of the substrate 42. However, in the liquid crystal display device, there may be provided a lens for expanding the light of the LED module 41 toward the left side of the substrate 42 intensively, and a lens for expanding the light of the LED module 41 toward the right side of the substrate 42 intensively.

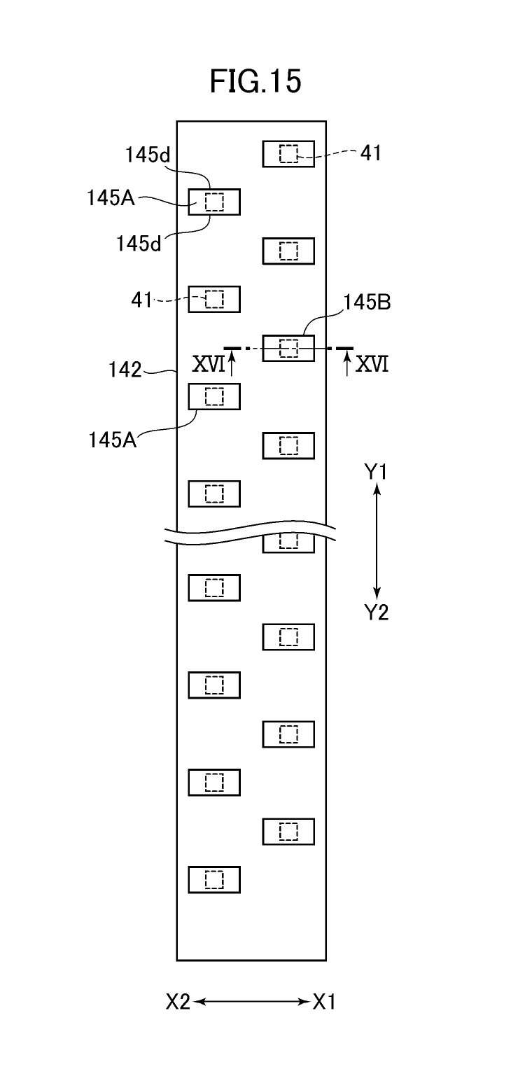

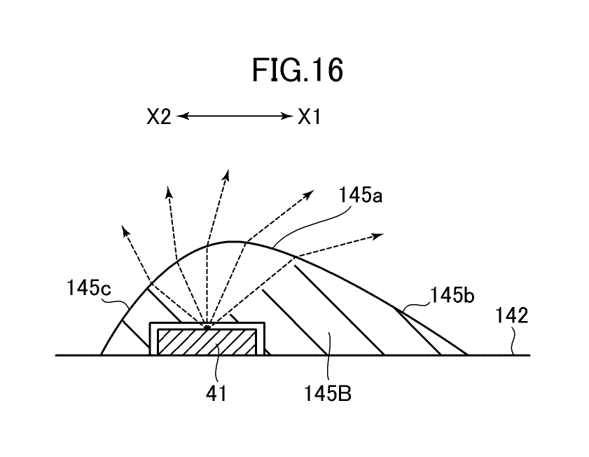

FIG. 15 is a plan view of a substrate 142 which is an example of such form. FIG. 16 is a cross-sectional view taken along the line XVI-XVI illustrated in FIG. 15.

As illustrated in FIG. 15, the substrate (light source region) 142 has a vertically-elongated shape similarly to the substrate 42. Also on the substrate 142, a plurality of LED modules 41 are arranged in a longitudinal direction of the substrate 142. In the example described here, the LED modules 41 are disposed in two rows in a staggered manner. That is, the LED modules 41 disposed in one row and the LED modules 41 disposed in the other row are arranged alternately in the vertical direction.

For the LED module 41, lenses 145A and 145B are disposed. In this example, the lens 145A (hereinafter, referred to as left lens) is disposed for each LED module 41 in the left row of the two rows of the LED modules 41. Further, the lens 145B (hereinafter, referred to as right lens) is disposed for each LED module 41 in the right row of the two rows of the LED modules 41.

To each of the LED modules 41, the partial region of the liquid crystal panel 2 is assigned, which is extended in the width direction of the substrate 142. In the example described here, to the LED module 41 disposed in the left row, a region extended leftward from a position opposed to the substrate 142 (that is, a center portion in the lateral direction of the liquid crystal panel 2) is assigned. On the other hand, to the LED module 41 disposed in the right row, a region extended rightward from the position opposed to the substrate 142 is assigned. In this way, when the LED modules 41 are disposed in a staggered manner, the partial regions E illustrated in FIG. 3 can be provided more finely so that close light emission control corresponding to scanning regions of a display screen can be performed.

The left lens 145A and the right lens 145B expand light of the LED modules 41 in opposite directions, respectively. In this example, the partial region associated with the left lens 145A is a region extended leftward, and the right lens 145B expands the light of the LED module 41 rightward. In other words, the left lens 145A enlarges the light divergence angle (see θ1 of FIG. 9) so that light is deflected leftward, and the right lens 145B enlarges the light divergence angle so that light is deflected rightward.

Each of the lenses 145A and 145B has a light exiting surface (top surface) expanded into a convex shape, but has a horizontally unsymmetrical shape unlike the lens 45. For example, a light exiting surface 145a of the right lens 145B has, as illustrated in FIG. 16, a gentle slope 145b and a steep slope 145c. The gentle slope 145b is inclined so as to approach the substrate 142 as being apart rightward from the apex of the right lens 145B. The steep slope 145c is inclined so as to approach the substrate 142 as being apart leftward from the apex. The inclination of the steep slope 145c is larger than the inclination of the gentle slope 145b. With such shape, the right lens 145B allows the light of the LED module 41 to exit rightward more than leftward. With this, the partial region on the liquid crystal panel 2 expanded rightward from the center portion corresponding to the right lens 145B is irradiated with the light from the LED module 41.

The left lens 145A has the same shape as that of the right lens 145B, but faces a different direction from the right lens 145B on the substrate 142. That is, the left lens 145A is disposed to be horizontally reversed from the right lens 145B. With this, the lens 145A allows the light of the LED module 41 to exit leftward more than rightward.

Further, in this example, as illustrated in FIG. 15, the lenses 145A and 145B each has, similarly to the lens 45 described above, a pair of side surfaces 145d extending downward from the upper and lower edges of the light exiting surface 145a toward the substrate 142. In this example, the side surfaces 145d are formed upright with respect to the substrate 142, that is, formed so as to be substantially parallel to the optical axis of the LED module 41. Therefore, the expanse of the divergence angle of light in the vertical direction (longitudinal direction of the substrate 142) by the lenses 145A and 145B is suppressed.

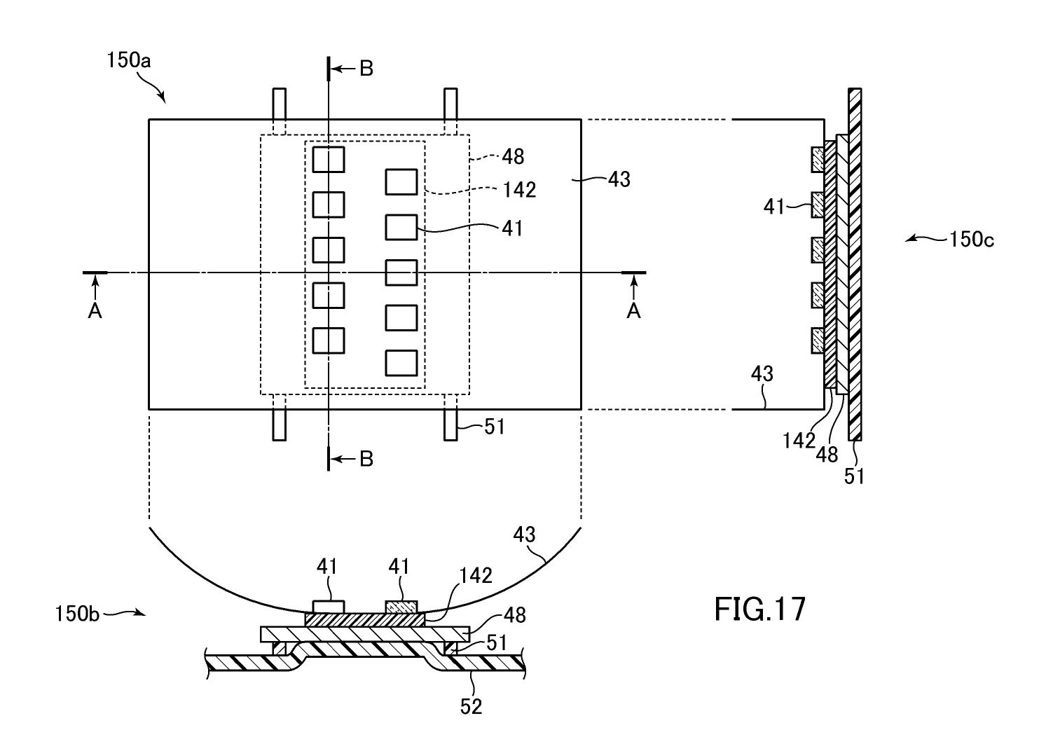

FIG. 17 is a schematic view illustrating a heat dissipation structure of the backlight unit 4 in the case where the LED modules 41 are arranged in a staggered manner, and illustrates a plan view 150a of the backlight unit 4, a horizontal cross-sectional view 150b taken along the line A-A illustrated in the plan view 150a, and a vertical cross-sectional view 150c taken along the line B-B illustrated in the plan view 150a. FIG. 17 is a simplified schematic view of the backlight unit 4, and similarly to FIG. 14, omits the lens 45, for example. Also in the backlight unit 4 illustrated in FIG. 17, similarly to the configuration illustrated in FIG. 14, two reinforcing members 51 extending in the vertical direction are fixed onto the rear surface of the backlight unit 4, the LED modules 41 are arrayed in a region between the two reinforcing members 51, and the rear cabinet 52 contacts the radiator plate 48 at a position behind the LED modules 41.

Note that, the above-mentioned embodiments have exemplified a configuration example in which the substrate 42 or 142 is formed of a single substrate, but the substrate 42 or 142 may be formed by arranging a plurality of substrates in the vertical direction (Y1-Y2) so as to have an elongated shape as a whole. For example, the substrate 42 or 142 may be disposed as being divided into two in the Y1-Y2 direction.

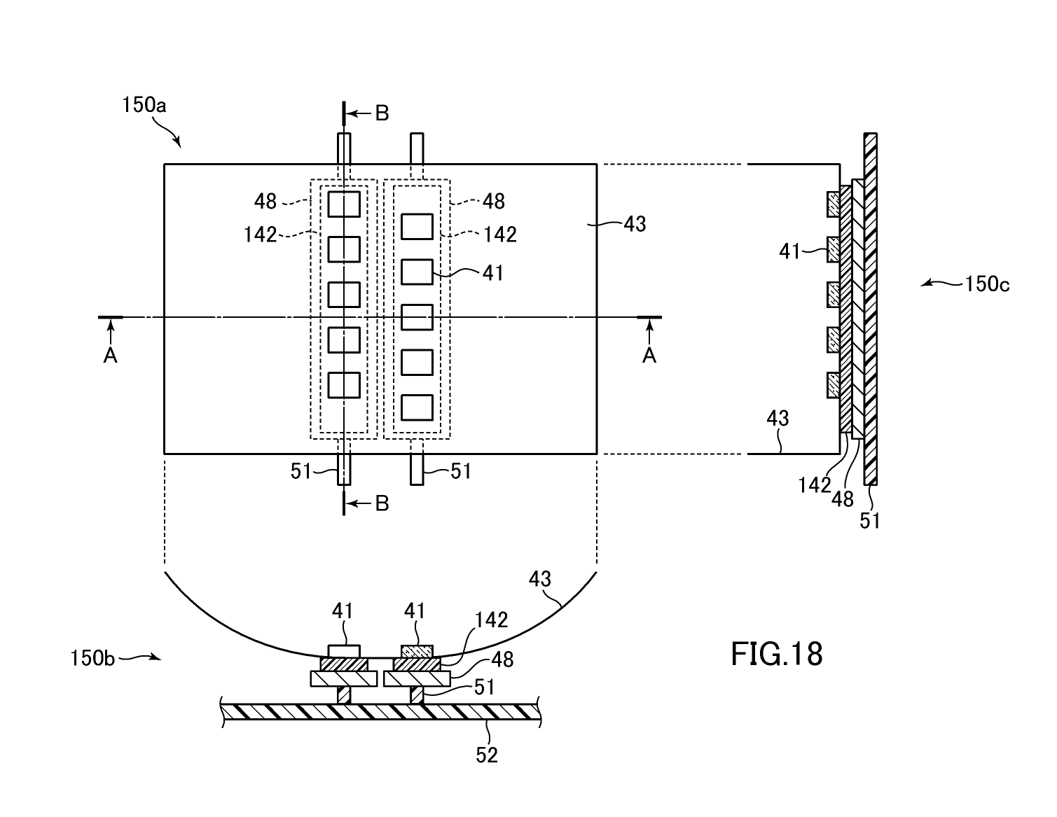

Further, the substrate 142 on which the LED modules 41 are disposed in the longitudinal direction in two rows may be divided into two in the lateral direction (X1-X2). FIG. 18 is a schematic view illustrating this configuration, and corresponds to FIG. 17 illustrating a single substrate 142. In the configuration illustrated in FIG. 18, each row of the LED modules 41 is disposed on one divided substrate. In the configuration of FIG. 18, the radiator plate 48 is also divided into two corresponding to the substrates 142, and a laminate body of the substrate 142 and the radiator plate 48, which is formed for each row of the LED modules 41, is fixed to a corresponding one reinforcing member 51. Note that, the substrate 142 is divided into two in the lateral direction, but the configurations of the radiator plates 48, the reinforcing members 51, and the rear cabinet 52 may be the same as those of FIG. 17.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a liquid crystal panel capable of displaying an image;
a backlight unit comprising a light source mounting substrate on which a plurality of light sources are disposed and which faces a rear surface of the liquid crystal panel; and
a control device for controlling brightness of the plurality of light sources, wherein:
the light source mounting substrate is shaped to have a longitudinal direction aligned in a vertical scanning direction of the image, and has the plurality of light sources disposed at a plurality of positions in the longitudinal direction;
the backlight unit further includes a lens, which is disposed above each of the plurality of light sources, for expanding light of the each of the plurality of light sources toward a region elongated in a transverse direction of the light source mounting substrate, the transverse direction being orthogonal to the longitudinal direction on the liquid crystal panel; and
the control device controls a light emission operation of the plurality of light sources in synchronization with selection of a scanning line in an operation of writing an image signal into the liquid crystal panel.

2. The liquid crystal display device according to claim 1, wherein:
the backlight unit further comprises a reflection sheet, which is disposed to be opposed to an image display region of the liquid crystal panel and reflects light from the plurality of light sources toward the image display region; and
the reflection sheet has a reflection surface, which forms a concave surface curved in the transverse direction of the light source mounting substrate.

3. The liquid crystal display device according to claim 1, further comprising a rear cabinet constituting a rear surface of the backlight unit, wherein:
the backlight unit further comprises a radiator plate, which is provided behind the plurality of light sources; and
the rear cabinet contacts the radiator plate.

4. The liquid crystal display device according to claim 3, further comprising reinforcing members, which are mounted to the rear cabinet and extend in the vertical scanning direction, wherein:
the light source mounting substrate is disposed face to face with a center portion of the liquid crystal panel in the transverse direction of the light source mounting substrate;
the reinforcing members are provided on both sides of a region in which the plurality of light sources are disposed; and
the radiator plate is disposed so as to straddle the reinforcing members disposed in parallel to each other.

5. The liquid crystal display device according to claim 1, wherein the light source mounting substrate is disposed face to face with a center portion of the liquid crystal panel in the transverse direction of the light source mounting substrate.

6. The liquid crystal display device according to claim 1, wherein the plurality of light sources on the light source mounting substrate are disposed in a row.

7. The liquid crystal display device according to claim 1, wherein the plurality of light sources on the light source mounting substrate are disposed in two rows in a staggered manner.

8. The liquid crystal display device according to claim 7, wherein:
the lens comprises a first lens, which is disposed on the light source in a left row of the two rows, and a second lens, which is disposed on the light source in a right row of the two rows;
the first lens is formed so that light from the light source expands leftward intensively; and
the second lens is formed so that the light from the light source expands rightward intensively.

9. The liquid crystal display device according to claim 1, wherein the light source mounting substrate comprises two light source mounting substrates disposed in parallel in the transverse direction.

10. The liquid crystal display device according to claim 9, wherein the light sources on one of the two light source mounting substrates and the light sources on another one of the two light source mounting substrates are each disposed in a row, and are disposed in a staggered manner.
